(19) United States
(12) Patent Application Publication
(10) Pub. No.: US 2014/0217831 A1
(43) Pub. Date: Aug. 7, 2014

(54) WIRELESS POWER TRANSMISSION DEVICE USING FREQUENCY MULTIPLIER AND METHOD THEREOF

(71) Applicant: Electronics & Telecommunications Research Institute, Daejeon (KR)

(72) Inventors: Chang Hee HYOUNG, Daejeon (KR); Sung Weon Kang, Daejeon (KR); Kyung Hwan Park, Daejeon (KR); Myung Ae Chung, Daejeon (KR)

(73) Assignee: Electronics & Telecommunications Research Institute, Daejeon (KR)

(21) Appl. No.: 14/175,952

(22) Filed: Feb. 7, 2014

(30) Foreign Application Priority Data
Feb. 7, 2013 (KR) 10-2013-0013669

(51) Int. Cl. H02J 17/00

(52) U.S. Cl. CPC H02J 17/00
USPC 307/104

(57) ABSTRACT

There are provided a wireless power transmission device using a frequency multiplier and a method thereof. The wireless power transmission device using the frequency multiplier includes a signal input unit configured to receive a first alternating current (AC) signal, a frequency multiplier configured to output a second AC signal having a higher frequency than the first AC signal using harmonic components of the first AC signal, and a power transmission unit configured to transmit power by receiving the second AC signal. Accordingly, a complex structure in which an AC signal is converted into a DC signal and the DC signal is converted into the AC signal again in order to generate the AC signal for the wireless power transmission can be simplified by the frequency multiplier. Moreover, it is possible to efficiently and wirelessly transmit low power required for ambient scattered sensor nodes.

### CLAIM FOR PRIORITY

This application claims priority to Korean Patent Application No. 10-2013-0013669 filed on Feb. 7, 2013 in the Korean Intellectual Property Office (KIPO), the entire contents of which are hereby incorporated by reference.

### BACKGROUND

1. Technical Field

Example embodiments of the present invention relate to wireless power transmission technology, and more specifically, to a wireless power transmission device using a frequency multiplier and a method thereof.

2. Related Art

Wireless power transmission refers to technology for wireless power supply without a power line of a device that uses electricity and can supply required power wirelessly and freely regardless of a location in which the device is positioned.

In particular, a portable terminal such as a smart phone and a tablet PC can freely and wirelessly deliver information via a mobile communication network or a wireless LAN (Wi-Fi). However, power of such a portable terminal is supplied with a built-in battery and therefore wires need to be connected whenever the terminal is charged.

Recently, interest in wireless power transmission technology in which power lines are removed in consideration of user convenience and which can supply power to the portable terminal is increasing. Collective standardization of wireless power transmission among chip manufacturers and terminal manufacturers has been carried out.

Meanwhile, the scope of the wireless power transmission technology is extending from devices requiring relatively low power such as the portable terminal to devices requiring more power.

FIG. 1 is a block diagram illustrating an existing wireless power transmission device. The existing wireless power transmission device 10 includes a transformer 11 (a kind of AC to AC converter) configured to receive power of a band of several Hz (usually 50 to 60 Hz) and adjust a signal level of an input AC signal to a desired level, a rectifier 12 configured to output a DC signal by rectifying the AC signal output from the transformer 11, a power converter 14 configured to generate a signal having a frequency band required for power transmission, and a source resonant unit 15.

Moreover, the existing wireless power transmission device 10 may further include a source controller 17 configured to adjust a DC voltage level generated in constant voltage controllers 13 and 16 by detecting power reflected according to load conditions. The existing wireless power transmission device 10 performs processes of converting the input AC signal into the DC signal and converting the DC signal into a signal having a frequency required for the wireless power transmission in order to obtain an output signal having a relatively higher frequency than the input AC signal.

Therefore, in order to generate an AC signal required for the wireless power transmission, the existing wireless power transmission device 10 basically uses an AC to DC converter, a DC to DC converter, and a DC to AC converter. Accordingly, when input power is low, power conversion efficiency according to each circuit decreases, final power conversion efficiency decreases, and a circuit configuration becomes complex.

### SUMMARY

Accordingly, example embodiments of the present invention are provided to substantially obviate one or more problems due to limitations and disadvantages of the related art.

Example embodiments of the present invention provide wireless transmission of power using a device having a simple structure using a frequency multiplier. Example embodiments of the present invention also provide wireless transmission of power to ambient scattered sensor nodes using a device having a simple structure using a frequency multiplier.

In some example embodiments, a wireless power transmission device includes a signal input unit configured to receive a first alternating current (AC) signal, a frequency multiplier configured to output a second AC signal having a higher frequency than the first AC signal using harmonic components of the first AC signal, and a power transmission unit configured to transmit power by receiving the second AC signal.

The first AC signal may be leakage power or interference power generated in an electronic device so it can be a 50 to 60 Hz band or several tens of kHz to several hundreds of MHz.

The signal input unit may include an antenna.

The frequency multiplier may be an active or passive frequency multiplier.

The frequency multiplier may include an input impedance matching circuit configured to match an input impedance of the first AC signal, a non-linear element, and an output impedance matching circuit configured to match an output impedance of the second AC signal.

The non-linear element may receive the first AC signal matched by the input impedance matching circuit, output the second AC signal by generating harmonic components of the matched first AC signal, and deliver the second AC signal to the output impedance matching circuit.

The non-linear element may be a diode or a transistor.

The wireless power transmission device may further include a constant voltage generator configured to generate a DC voltage from the first AC signal and provide the voltage to the transistor.

The second AC signal may be output using a second-order harmonic wave of the first AC signal.

The power transmission unit may include a source resonant unit configured to transmit power using a resonance characteristic of the second AC signal.

The power transmission unit may include a primary inductive power generator configured to generate an induced current using the second AC signal.

In other example embodiments, a wireless power transmission method includes receiving a first alternating current (AC) signal, outputting a second AC signal having a higher frequency than the first AC signal using harmonic components of the first AC signal, and transmitting power by receiving the second AC signal.

In the outputting of the second AC signal, the second AC signal may be output by generating harmonic components of the first AC signal using a non-linear element that is either a diode or a transistor.

In the wireless power transmission device using the frequency multiplier and the method thereof according to the embodiments of the invention described above, a complex structure in which the AC signal is converted into the DC signal and the DC signal is converted into the AC signal again in order to generate the AC signal for the wireless power transmission can be simplified by the frequency multiplier

Accordingly, it is possible to implement the wireless power transmission device with a simple structure and decrease a loss generated in power transmission processes.

Moreover, it is possible to efficiently and wirelessly transmit low power required for ambient scattered sensor nodes.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating an existing wireless power transmission device.

FIG. 2 is a conceptual diagram illustrating operations of a frequency multiplier.

FIG. 3 is a conceptual diagram illustrating operations of a frequency multiplier using a second-order harmonic wave.

FIG. 4 is a block diagram illustrating a passive frequency multiplier using a diode.

FIG. 5 is a block diagram illustrating an active frequency multiplier using a transistor.

FIG. 6 is a conceptual diagram illustrating wireless power transmission using the passive frequency multiplier according to an embodiment of the invention.

FIG. 7 is a block diagram illustrating a wireless power transmission device using the passive frequency multiplier according to the embodiment of the invention.

FIG. 8 is a conceptual diagram illustrating wireless power transmission using the active frequency multiplier according to the embodiment of the invention.

FIG. 9 is a block diagram illustrating a wireless power transmission device using the active frequency multiplier according to the embodiment of the invention.

FIG. 10 is a flowchart illustrating a wireless power transmission method according to the embodiment of the invention.

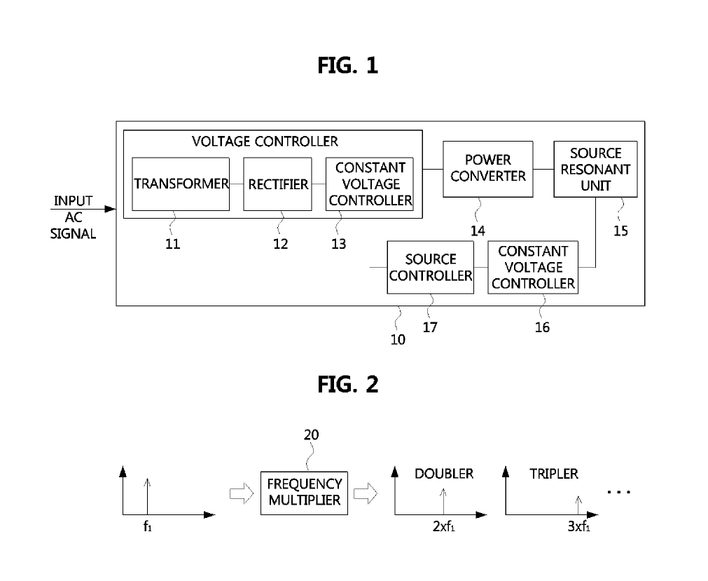

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, terminology of wireless power transmission used in the invention will be briefly described below.

Wireless power transmission is a new concept of a power transmission method in which energy is delivered by converting electric energy into microwaves favorable for wireless transmission.

Wireless power transmission uses a principle of radio transmission in which electric energy is wirelessly transmitted through a space without wires, and is a different concept from a signal used in a wireless communication method such as a radio or a wireless phone. That is, while common communication is performed by a carrier having a signal therein, wireless power transmission may refer to transmitting only the carrier.

As a frequency increases, the electric energy having an amplitude and frequency has characteristics of a radio wave that can be wirelessly transmitted in a free space. That is, a higher frequency results in a shorter wavelength, and thereby a wave has linearity similar to light. Therefore, it is possible to transmit the electric energy by collecting it in one place. Wireless power transmission is power transmission technology that uses such radio wave characteristics.

Hereinafter, exemplary embodiments of the invention will be described in detail with reference to the accompanying drawings.

FIG. 2 is a conceptual diagram illustrating operations of a frequency multiplier.

As illustrated in FIG. 2, a frequency multiplier 20 outputs a signal having a frequency of an integer multiple of an input frequency. The frequency multiplier 20 generates the frequency using harmonic components generated by non-linearity of an element.

If a sinusoid is applied to a nonlinear system, the output generally exhibits frequency components that are integer multiples of the input frequency. In Eq. (1), if x(t)=A cos Ωt, then

$$y ( t ) = {α}_{1} x ( t ) + {α}_{2} {x}^{2} ( t ) + {α}_{3} {x}^{3} ( t ) ( ) \\ then \\ \begin{matrix}y ( t ) = {α}_{1} A cos ω t + {α}_{2} {A}^{2} {cos}^{2} ω t + {α}_{3} {A}^{3} {cos}^{3} ω t ( ) \\ = {α}_{1} A cos ω t + \frac{{α}_{3} {A}^{2}}{2} ( 1 + cos 2 ω t ) + \frac{{α}_{3} {A}^{3}}{4} ( 3 cos ω t + cos 3 ω t ) ( ) \\ = \frac{{α}_{2} {A}^{2}}{2} + ( {α}_{1} A + \frac{3 {α}_{3} {A}^{3}}{4} ) cos ω t + \frac{{α}_{2} {A}^{2}}{2} cos 2 ω t + \frac{{α}_{3} {A}^{3}}{4} cos 3 ω t ( )\end{matrix} \qquad$$

In Eq. (4), the term with the input frequency is called the “fundamental” and the higher-order terms the “harmonics.”

In general, an alternating current (AC) signal is composed of a sum of a sine wave (or a fundamental wave) determining a frequency of an entire signal and a wave having a frequency of an integer multiple of the sine wave. Here, the wave having a frequency of an integer multiple of the sine wave is called a harmonic wave.

That is, when a wave having constant periodicity is decomposed, the wave can be divided into a fundamental wave having the lowest frequency and harmonic waves having two times, three times, . . . , and n times the frequency of the fundamental wave. Here, the harmonic waves having, for example, two times and three times the frequency may be respectively represented as a second-order harmonic wave and a third-order harmonic wave.

For example, a sawtooth wave is composed of a fundamental wave and harmonic waves having two times, three times, four times, . . . , the frequency of the fundamental wave, and a square wave is composed of a fundamental wave and harmonic waves having three times, five times, seven times, . . . , a frequency of the fundamental wave.

The frequency multiplier 20 may be classified as a passive frequency multiplier (passive type) using a diode or an active frequency multiplier (active type) using a transistor.

For example, the active frequency multiplier multiplies (2×f₁ or 3×f₁) the frequency using a second-order or third-order harmonic wave component generated by a fundamental wave (f₁) in a field effect transistor (FET) or a bipolar junction transistor (BJT).

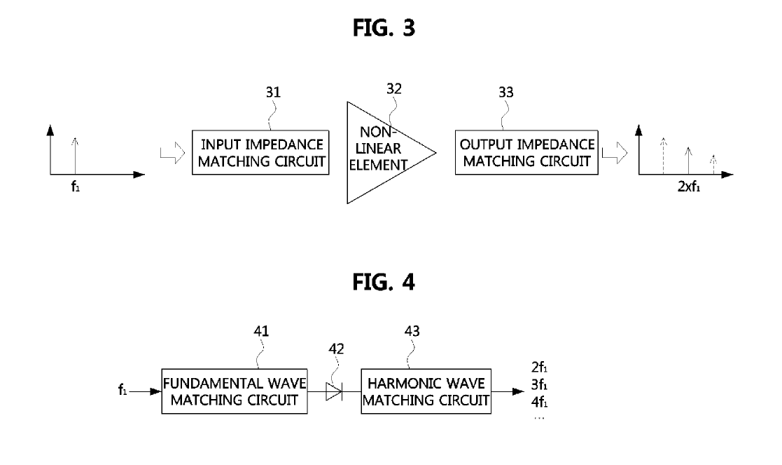

FIG. 3 is a conceptual diagram illustrating operations of the frequency multiplier using the second-order harmonic wave.

The frequency multiplier using the second-order harmonic wave will be described with reference to FIG. 3. The frequency multiplier 20 includes an input impedance matching circuit 31, a non-linear element 32, and an output impedance matching circuit 33. The non-linear element 32 receives an input AC signal (f₁) from the input impedance matching circuit 31, generates a harmonic wave, and delivers the generated harmonic wave to the output impedance matching circuit 33.

For example, the non-linear element 32 may generate a second-order harmonic wave (2×f₁) from the input AC signal (f₁) and deliver the generated wave to the output impedance matching circuit 33. Here, the frequency multiplier 20 that outputs the signal having two times the frequency of the fundamental wave using the second-order harmonic wave may be called a frequency doubler. In this case, the non-linear element 32 may output the signal having a frequency (2×f₁) of the second-order harmonic wave. Moreover, the input impedance matching circuit 31 is designed to match an input impedance of the input AC signal (f₁) and the output impedance matching circuit 33 is designed to match an output impedance of the second-order harmonic wave (2×f₁).

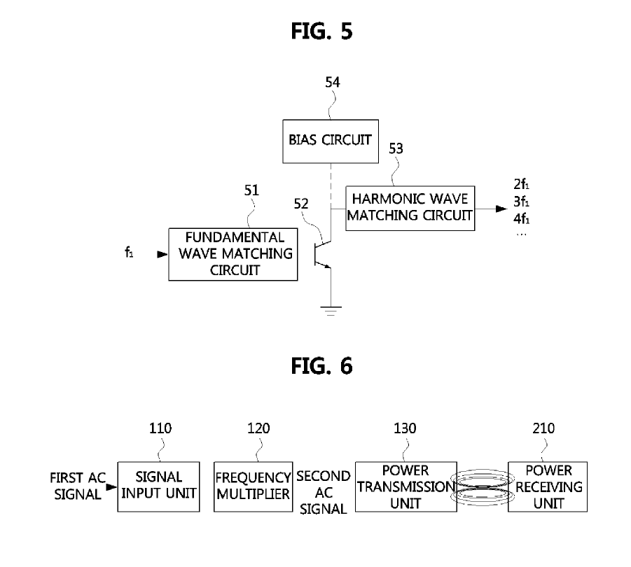

FIG. 4 is a block diagram illustrating the passive frequency multiplier using the diode. FIG. 5 is a block diagram illustrating the active frequency multiplier using a transistor.

The frequency multiplier 20 may be classified by a type of the non-linear element 32 to be used. That is, the frequency multiplier 20 using the diode as the non-linear element 32 may be called the passive (passive type) frequency multiplier, and the frequency multiplier 20 using the transistor as the non-linear element 32 may be called the active (active type) frequency multiplier.

As illustrated in FIG. 4, the passive frequency multiplier includes a fundamental wave matching circuit 41, a diode 42, and a harmonic wave matching circuit 43.

The diode 42 may generate a harmonic wave from the input signal based on non-linearity of the element and deliver the wave to the harmonic wave matching circuit 43. Moreover, the fundamental wave matching circuit 41 is designed to match an input impedance of the input signal, and the harmonic wave matching circuit 43 is designed to match an output impedance of the output harmonic wave.

As illustrated in FIG. 5, the active frequency multiplier includes a fundamental wave matching circuit 51, a transistor 52, a harmonic wave matching circuit 53, and a bias circuit 54.

The transistor 52 may generate a harmonic wave from the input signal based on non-linearity of the element and deliver the wave to the harmonic wave matching circuit 53. Here, the transistor 52 may be the field effect transistor (FET) or the bipolar junction transistor (BJT).

The fundamental wave matching circuit 51 is designed to match an input impedance of the input signal, the harmonic wave matching circuit 53 is designed to match an output impedance of the output harmonic wave, and the bias circuit 54 generates a DC voltage from the input signal and provides the voltage to the transistor 52. The bias circuit 54 may be implemented by the rectifier and a voltage booster or voltage multiplier.

FIG. 6 is a conceptual diagram illustrating wireless power transmission using the passive frequency multiplier according to the embodiment of the invention.

As illustrated in FIG. 6, the wireless power transmission according to the embodiment of the invention may be performed by a wireless power transmission device configured to transmit power and a wireless power receiving unit configured to receive power.

The wireless power transmission device according to the embodiment of the invention includes a signal input unit 110, a frequency multiplier 120, and a power transmission unit 130.

The signal input unit 110 may receive a first AC signal as the input signal. The signal input unit 110 may deliver the input first AC signal to the frequency multiplier 120. The signal input unit 110 may have a shape of an antenna to obtain the leaked electromagnetic wave or a conductive electrode to receiving conducted electromagnetic interference.

The frequency multiplier 120 may output a second AC signal having a higher frequency than the first AC signal using harmonic components of the first AC signal.

The wireless power transmission device according to the embodiment of the invention may transmit power using the passive frequency multiplier. That is, the wireless power transmission device may include the passive frequency multiplier using the diode.

The power transmission unit 130 may receive the second AC signal from the frequency multiplier 120 and transmit power using an induced current or a resonance characteristic of the second AC signal.

Furthermore, the wireless power receiving unit may include a power receiving unit 210. The power receiving unit 210 may receive power based on the induced current or the resonance characteristic of the second AC signal. Accordingly, the power receiving unit 210 may include a resonant circuit (target resonant unit) using a condenser and an inductance coil or an induction coil (secondary induced power generator) for generating an induced current.

However, the wireless power receiving unit may include a variety of circuits other than the power receiving unit 210 and detailed description thereof will be omitted.

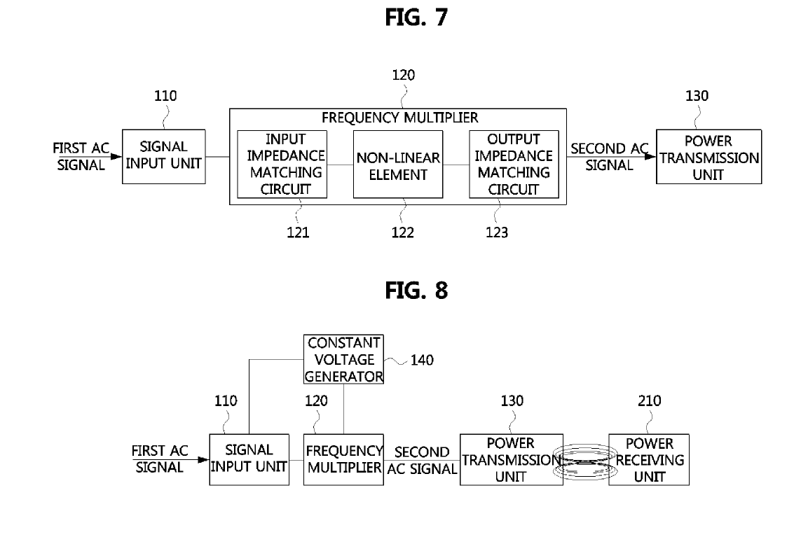

FIG. 7 is a block diagram illustrating the wireless power transmission device using the passive frequency multiplier according to the embodiment of the invention.

As illustrated in FIG. 7, the wireless power transmission device according to the embodiment of the invention may include the signal input unit 110, the frequency multiplier 120, and the power transmission unit 130. The frequency multiplier 120 may include an input impedance matching circuit 121, a non-linear element 122, and an output impedance matching circuit 123.

The signal input unit 110 may receive the first AC signal. For example, recently, in order to provide a location-based service or efficiently manage power, research on and demand for sensor network technology for collecting and monitoring information on ambient conditions are increasing in various fields. However, in order to provide such new services, significant costs are incurred when wirings for supplying power are constructed. Therefore, many sensor network nodes use their own power but it is difficult to continuously maintain and manage power due to a limited battery capacity.

In addition, many electronic devices internally have a variety of operating frequencies. In order to internally obtain the operating frequency required for operating a circuit from the AC signal having a 50 to 60 Hz band applied from the outside, the AC to DC converter and the DC to DC converter are used, and finally the DC to AC converter is used, thereby obtaining the operating frequency required for driving the circuit. Then, the operating frequency obtained through these conversion processes may be conducted outside of the electronic device and may be leaked in a form of an electromagnetic wave.

That is, it is possible to drive the wireless power transmission device using this unintended conductive interference signal or electromagnetic interference signal as an input signal.

According to the embodiment of the invention, it is possible to wirelessly transmit power using leakage power or interference power generated in the electronic device as the input signal.

That is, the invention may transmit power to the electronic device including the sensor node requiring low power through frequency conversion processes using the AC signal obtained by, for example, the leakage power of various electronic devices.

Therefore, the signal input unit 110 may use the leakage power or the interference power as the input signal and may have a shape of an antenna to obtain the leaked electromagnetic wave.

Further, according to the embodiment of the invention, since the frequency used in the power transmission has a relatively low frequency of several hundreds of kHz to several hundreds of MHz, when it is difficult to physically implement the antenna for obtaining the electromagnetic wave of such a band, the signal input unit 110 may include a structure for obtaining the electromagnetic wave even when the band is not an exact operating band.

The frequency multiplier 120 may receive the first AC signal from the signal input unit 110 and output the second AC signal having a higher frequency than the first AC signal using the harmonic components of the first AC signal.

The frequency multiplier 120 may include an impedance matching unit and the non-linear element 122. The impedance matching unit may include the input impedance matching circuit 121 and the output impedance matching circuit 123, and may use the diode as the non-linear element 122.

That is, the non-linear element 122 may receive the first AC signal having an input impedance matched by the input impedance matching circuit 121, and output the second AC signal by generating harmonic components of the first AC signal having the matched input impedance, and deliver the output second AC signal to the output impedance matching circuit 123. Here, the harmonic components of the first AC signal may be, for example, a second-order harmonic wave or a third-order harmonic wave.

For example, as opposed to the input signal (first AC signal) generally having a low-frequency component of a 50 to 60 Hz band, the frequency (second AC signal) used in the wireless power transmission may have a relatively higher frequency than the input signal of a band of several hundreds of kHz to several tens of MHz.

Moreover, the input impedance matching circuit 121 is designed to match an input impedance of the first AC signal and the output impedance matching circuit 123 is designed to match an output impedance of the second AC signal.

The power transmission unit 130 may include a source resonant unit configured to transmit power using the resonance characteristic of the second AC signal. Further, the power transmission unit 130 may include a primary inductive power generator configured to generate an induced current using the second AC signal.

For example, the source resonant unit may include the resonant circuit using the condenser and the inductance coil. The primary inductive power generator may include the induction coil for generating the induced current.

Therefore, the wireless power transmission device according to the embodiment of the invention may be implemented by a resonance method or an induction method.

FIG. 8 is a conceptual diagram illustrating wireless power transmission using the active frequency multiplier according to the embodiment of the invention. FIG. 8 may be understood with reference to FIG. 6.

As illustrated in FIG. 8, the wireless power transmission according to the embodiment of the invention may be performed by the wireless power transmission device configured to transmit power and the wireless power receiving unit configured to receive power.

The wireless power transmission according to the embodiment of the invention includes the signal input unit 110, the frequency multiplier 120, the power transmission unit 130, and a constant voltage generator 140.

The signal input unit 110 may receive the first AC signal as the input signal. The signal input unit 110 may deliver the input first AC signal to the frequency multiplier 120.

The frequency multiplier 120 may output the second AC signal having a higher frequency than the first AC signal using the harmonic components of the first AC signal.

The wireless power transmission device according to the embodiment of the invention may transmit power using the active frequency multiplier. That is, the wireless power transmission device may include the active frequency multiplier using the transistor.

The power transmission unit 130 may receive the second AC signal from the frequency multiplier 120 and transmit power using the induced current or the resonance characteristic of the second AC signal.

The constant voltage generator 140 may generate a DC voltage from the first AC signal and provide the voltage to the transistor.

Moreover, the wireless power receiving unit may include the power receiving unit 210. The power receiving unit 210 may receive power based on the induced current or the resonance characteristic of the second AC signal. Accordingly, the power receiving unit 210 may include the resonant circuit (target resonant unit) using the condenser and the inductance coil or the induction coil (secondary induced power generator) for generating the induced current.

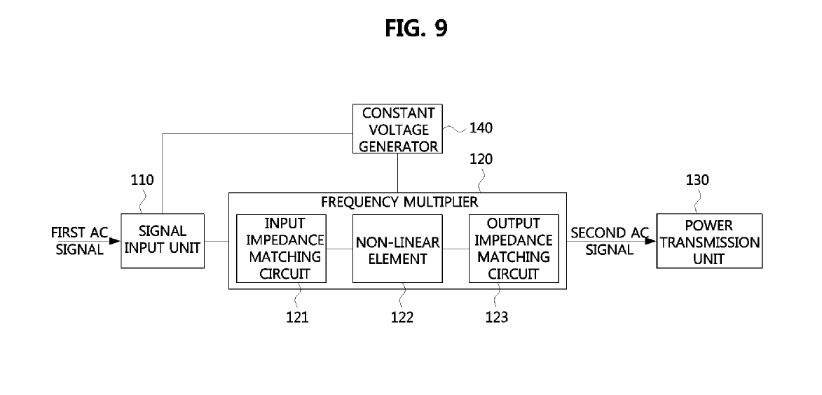

FIG. 9 is a block diagram illustrating the wireless power transmission device using the active frequency multiplier according to the embodiment of the invention. FIG. 9 may be understood with reference to FIG. 7.

As illustrated in FIG. 9, the wireless power transmission device according to the embodiment of the invention includes the signal input unit 110, the frequency multiplier 120, the power transmission unit 130, and the constant voltage generator 140.

The signal input unit 110 may receive the first AC signal.

The signal input unit 110 may use the unintended conductive interference signal or electromagnetic interference signal as the input signal.

According to the embodiment of the invention, it is possible to wirelessly transmit power using the leakage power or the interference power generated in the electronic device as the input signal.

Therefore, the signal input unit 110 may use the leakage power or the interference power as the input signal and may have a shape of an antenna to obtain the leaked electromagnetic wave.

The frequency multiplier 120 may receive the first AC signal from the signal input unit 110 and output the second AC signal having a higher frequency than the first AC signal using the harmonic components of the first AC signal.

The frequency multiplier 120 may include the impedance matching unit and the non-linear element 122. The impedance matching unit may include the input impedance matching circuit 121 and the output impedance matching circuit 123, and may use the transistor as the non-linear element 122.

Moreover, the frequency multiplier 120 may be configured with a switching mode amplifier including, for example, a class C amplifier.

The non-linear element 122 may receive the first AC signal having an input impedance matched by the input impedance matching circuit 121, output the second AC signal using the harmonic components of the first AC signal having the matched input impedance, and deliver the output second AC signal to the output impedance matching circuit 123. Here, the harmonic components of the first AC signal may be, for example, a second-order harmonic wave or a third-order harmonic wave.

Moreover, the input impedance matching circuit 121 is designed to match an input impedance of the first AC signal and the output impedance matching circuit 123 is designed to match an output impedance of the second AC signal.

The power transmission unit 130 may include a source resonant unit configured to transmit power using the resonance characteristic of the second AC signal. Further, the power transmission unit 130 may include a primary inductive power generator configured to generate an induced current using the second AC signal.

That is, the source resonant unit may include the resonant circuit using the condenser and the inductance coil. The primary inductive power generator may include the induction coil for generating the induced current.

The constant voltage generator 140 may generate a DC voltage from the input signal and deliver the voltage to the non-linear element 122. That is, the constant voltage generator 140 may generate a DC voltage from the first AC signal and deliver the voltage to the transistor. For example, the constant voltage generator 140 is an element for obtaining a DC voltage required for driving an active non-linear element (transistor) and may be implemented by the rectifier and a voltage booster.

According to the embodiment of the invention, a communication function capable of controlling the output power according to the load conditions of the power transmission unit 130 may be further included. For example, it is also possible to implement a voltage regulating circuit such that the load conditions of the primary induction power generator or the source resonant unit can be controlled for optimization.

In the wireless power transmission device according to the embodiment of the invention described above, a complex structure in which the AC signal is converted into the

DC signal and the DC signal is converted into the AC signal again in order to generate the AC signal for the wireless power transmission can be simplified by the frequency multiplier 120. That is, it is possible to obtain the AC signal required for the power transmission with a simple structure using the frequency multiplier without converting the AC signal applied from the outside into the DC signal.

The wireless power transmission device according to the embodiment of the invention may efficiently and wirelessly transmit low power required for the ambient scattered sensor nodes.

Moreover, while each component of the wireless power transmission device according to the embodiment of the invention is listed and described by a respective configuration unit for convenience of description, at least two units among configuration units may be combined into one configuration unit, or one configuration unit may be split into several configuration units to perform functions. Such integrated and separated embodiments of each of the configuration units fall within the scope of the invention without departing from the spirit of the invention.

Further, the above-described configuration units are components defined by a functional classification rather than a physical classification and may be defined by functions performed by each configuration unit. Each of the configuration units may be implemented by hardware and/or a program code performing each function, and a processing unit. Therefore, a name given to the configuration unit in the embodiment is meant to imply a representative function performed by each configuration unit rather than to physically distinguish each configuration unit. It should be noted that the technological scope of the invention is not limited to the name of the configuration unit.

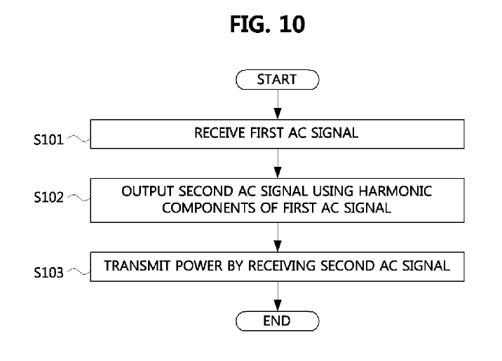

FIG. 10 is a flowchart illustrating a wireless power transmission method according to the embodiment of the invention.

As illustrated in FIG. 10, the wireless power transmission method according to the embodiment of the invention includes receiving a first AC signal (S101), outputting a second AC signal (S102), and transmitting power by receiving the second AC signal (S103).

A signal input unit 110 may receive the first AC signal (S101).

For example, it is possible to perform wireless power transmission using unintended leakage power or electromagnetic wave interference power as an input signal.

In the wireless power transmission method according to the embodiment of the invention, power may be wirelessly transmitted using the leakage power or the interference power generated in the electronic device as the input signal.

That is, the invention may transmit power to the electronic device including the sensor node requiring low power through frequency conversion processes using the AC signal obtained by, for example, the leakage power of various electronic devices.

It is possible to output the second AC signal having a higher frequency than the first AC signal using harmonic components of the first AC signal by receiving the first AC signal (S102). Here, the second AC signal may be output using a second-order harmonic wave of the first AC signal.

It is possible to output the second AC signal by generating the harmonic components from the first AC signal using a non-linear element that is either a diode or a transistor.

For example, as opposed to the input signal (first AC signal) generally having a low-frequency component of a 50 to 60 Hz band, the frequency (second AC signal) used in the wireless power transmission may have a relatively higher frequency than the input signal of a band of several hundreds of kHz to several tens of MHz.

It is possible to transmit power using an induced current or a resonance characteristic of the second AC signal by receiving the second AC signal (S103).

For example, it is possible to transmit power using a resonant circuit including a condenser and an inductance coil or an induction coil for generating the induced current.

Accordingly, the wireless power transmission method according to the embodiment of the invention may be implemented by a resonance method or an induction method.

Since the wireless power transmission method according to the embodiment of the invention may be performed by the wireless power transmission device described above, it may be clearly understood with reference to the descriptions of the above-described wireless power transmission device.

While the example embodiments of the present invention and their advantages have been described in detail, it should be understood that various changes, substitutions and alterations may be made herein without departing from the scope of the invention as defined by the following claims.

Reference Numerals

| | |
|---|---|
| 20, 120: frequency multiplier | 31, 121: input impedance matching circuit |
| 32, 122: non-linear element | 33, 123: output impedance matching circuit |
| 41, 51: fundamental wave matching circuit | 42: diode |
| 43, 53: harmonic wave matching circuit | 52: transistor |
| 54: bias circuit | 110: signal input unit |
| 130: power transmission unit | 140: constant voltage generator |
| 210: power receiving unit | |

What is claimed is:

1. A wireless power transmission device, comprising:
a signal input unit configured to receive a first alternating current (AC) signal;
a frequency multiplier configured to output a second AC signal having a higher frequency than the first AC signal using harmonic components of the first AC signal; and
a power transmission unit configured to transmit power by receiving the second AC signal.

2. The device of claim 1, wherein the first AC signal is leakage power or interference power generated in an electronic device.

3. The device of claim 2, wherein the signal input unit includes an antenna.

4. The device of claim 1, wherein the frequency multiplier is an active or passive frequency multiplier.

5. The device of claim 1, wherein the frequency multiplier includes:
an input impedance matching circuit configured to match an input impedance of the first AC signal;
a non-linear element; and
an output impedance matching circuit configured to match an output impedance of the second AC signal.

6. The device of claim 5, wherein the non-linear element receives the first AC signal matched by the input impedance matching circuit, outputs the second AC signal by generating harmonic components of the matched first AC signal, and delivers the second AC signal to the output impedance matching circuit.

7. The device of claim 5, wherein the non-linear element is a diode.

8. The device of claim 5, wherein the non-linear element is a transistor.

9. The device of claim 8, further comprising a constant voltage generator configured to generate a DC voltage from the first AC signal and provide the voltage to the transistor.

10. The device of claim 1, wherein the second AC signal is output using a second-order harmonic wave of the first AC signal.

11. The device of claim 1, wherein the power transmission unit includes a source resonant unit configured to transmit power using a resonance characteristic of the second AC signal.

12. The device of claim 1, wherein the power transmission unit includes a primary inductive power generator configured to generate an induced current using the second AC signal.

13. A wireless power transmission method, comprising:
receiving a first alternating current (AC) signal;
outputting a second AC signal having a higher frequency than the first AC signal using harmonic components of the first AC signal; and
transmitting power by receiving the second AC signal.

14. The method of claim 13, wherein the first AC signal receives leakage power or interference power generated in an electronic device.

15. The method of claim 13, wherein, in the outputting of the second AC signal, the second AC signal is output by generating harmonic components of the first AC signal using a non-linear element that is either a diode or a transistor.

16. The method of claim 13, wherein, in the transmitting of the power by receiving the second AC signal, the power is transmitted using a resonance characteristic of the second AC signal.

17. The method of claim 13, wherein, in the transmitting of the power by receiving the second AC signal, the power is transmitted by generating induction power using the second AC signal.

18. The method of claim 13, wherein the second AC signal is output using a second-order harmonic wave of the first AC signal.
